(19) United States
(12) Patent Application Publication
(10) Pub. No.: US 2009/0128773 A1
(43) Pub. Date: May 21, 2009

(54) Eyeglasses with attached second lenses

(76) Inventor: Ching-Yun Wang, Tainan (TW)

Correspondence Address: BACON & THOMAS, PLLC, 625 SLATERS LANE, FOURTH FLOOR, ALEXANDRIA, VA, 22314-1176, US

(21) Appl. No.: 12/292,487

(22) Filed: Nov. 20, 2008

(30) Foreign Application Priority Data
Nov. 20, 2007 (TW) 096219613

(51) Int. Cl. G02C 9/02

(52) U.S. Cl. 351/57

(57) ABSTRACT

This invention is to provide a structural combination of eyeglasses with attached second lenses, comprising an eyeglasses frame, a first lenses and a second lenses, where the eyeglasses frame is provided with protruded sockets at the appropriate locations on the left and right of the top rim, and the socket has a trough shaping multiple corners at its internal and having the entry facing ahead, while the second lenses is provided with a pivot rod in the shape of cornered pillar corresponding to each of the trough on the eyeglasses frame, through the cornered-pillar pivot rods are lodged in the cornered-groove troughs of the eyeglasses frame respectively, a firm combination is formed, where the second lenses is then available to be lifted or lowered in front of the first lenses, which achieves to position the clip-on lenses precisely.

### BACKGROUND OF THE INVENTION

1. Field of the Invention

The present invention relates to structural combinations of eyeglasses with attached second lenses, and in particular to an eyeglasses frame that is provided with protruded sockets at the appropriate locations on the left and right of the top rim, where the socket has a trough shaping multiple corners and having an entry facing ahead. The second lenses are provided with a pivot rod in the shape of multiple corners at each location corresponding to the trough of the eyeglasses frame. Through the pivot rods being pressed into the troughs, a firm combination is formed, where the second lenses is then available to be lifted or lowered in front of the first lenses.

2. Description of the Prior Art

Popular clip-on sunglasses (it means the second lenses) make use of an attachment device having a hook or a clip, to have the clip-on lenses hooked or clipped at the front of the eyeglasses. However, the attachment device using the hook or the clip is susceptible to instability in the hooking or the clipping, which makes the clip-on lenses fail to juxtapose tightly with the eyeglasses. Suppose the user is right in driving or exercising, it is highly possible that the vibrations could drop the clip-on lenses or part of it which brings in vague sight and the consequence for that matter would deteriorate the driving considerably. The other type of the clip-on sunglasses makes use of magnetism, where magnets are set up at the eyeglasses frame, and the magnets also set up at the clip-on sunglasses frame. By means of the magnetic attraction, the clip-on lenses are attached to the eyeglasses. However, the space available for installing the magnets is limited, and the conventional attachment device is to install the magnets at the outer surfaces of both sides of the eyeglasses frame, or to take advantage of the nose pad stand or the middle frame, which substantially complicates the eyeglasses manufacturing, and in turn lifts the production cost. And once the clip-on lenses is taken off, the installed magnets are exposed apparently, which makes the eyeglasses inferior in the look.

### SUMMARY OF THE INVENTION

In the light of the above urgent demand, this inventor conceived the idea for the research and development, and eventually the longtime endeavors gave birth to this invention.

To accomplish the aforementioned objects, this invention is to design a structural combination of an eyeglasses with attached second lenses, comprising an eyeglasses frame, a first lenses and a second lenses, where the eyeglasses frame is provided with protruded sockets at the top rim, and the socket has a trough in the shape of multiple corners at its internal, while the second lenses is provided with pivot rods in the shape of multiple corners, and the pivot rods are lodged in the troughs of the eyeglasses frame, once the pivot rods of the second lenses are in pivot connection with the troughs of the eyeglasses frame, the user is ready to lift or lower the second lenses, subject to the demand

In this invention, the entry of the trough of the socket faces preferably the front of the eyeglass.

In this invention, the entry of the trough of the socket is provided with a guiding slope leaned outward.

In this invention, the second lenses are provided with an opening below the body of each pivot rod.

### BRIEF DESCRIPTION OF THE DRAWINGS

FIG. 1 is a three-dimensional exploded view of the exemplified embodiment of the present invention;

FIG. 2 is a schematic exploded sectional view of the partial enlargement of the first and the second lenses of the exemplified embodiment of the present invention;

FIG. 3 is an exploded view of the partial enlargement of the first and the second lenses after their pivot connection of the exemplified embodiment of the present invention;

FIG. 4 is an exploded view of the partial enlargement of the lifting of the second lens after the first and the second lenses are in pivot connection of the exemplified embodiment of the present invention;

FIG. 5 is a three-dimensional exterior view of the lifting of the second lens of the exemplified embodiment of the present invention; and

FIG. 6 is a three-dimensional exterior view of the lowering of the second lens of the exemplified embodiment of the present invention.

### DETAILED DESCRIPTION OF THE INVENTION

To achieve the foregoing objects of the present invention, the techniques adopted and the achievable functioning are detailed described with reference to the following preferred exemplified embodiments and the accompanying drawings, which helps a thorough comprehension of the present invention.

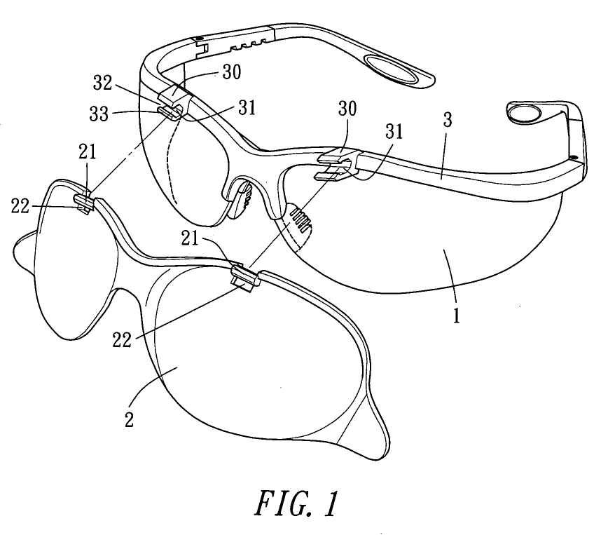

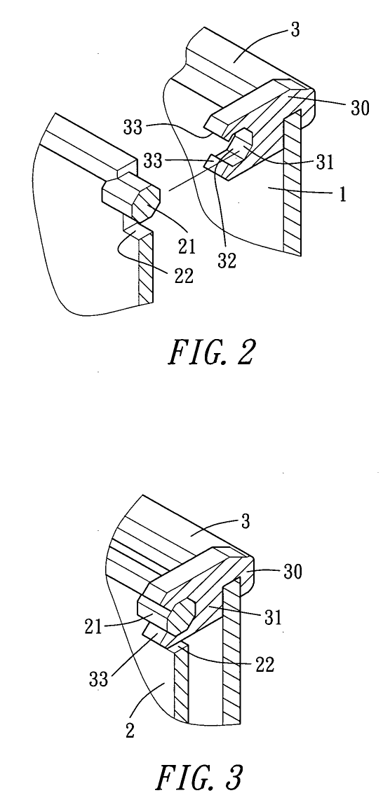

Referring to FIGS. 1 & 2, these figures are a three-dimensional exploded view and a schematic exploded sectional view of the partial enlargement of the exemplified embodiment of the present invention, which comprises an eyeglasses frame 3, a socket 31, a first lenses 1, a second lenses 2 and a pivot rod 21, wherein:

the eyeglasses frame 3, hung on the user's ears through its clamping arms at both sides, and also supported by the nose pads on the nasal bridge, where the eyeglasses frame 3 is provided with a socket 30 at each appropriate location of both sides of the top rim, and the socket 30 each has a trough 31 in the shape of multiple corners at its internal. The socket 30 and the trough 31 are set up with symmetry on the left and right, and the entry 32 of the trough 31 faces preferably the front of the eyeglasses;

the first lenses 1, mounted at the bottom of the eyeglasses frame 3, and positioned ahead of the eyes once it is in use;

the second lenses 2, a clip-on lenses compared to the first lenses 1, which is capable of being attached to or detached from the eyeglasses frame 3. The pivot rod 21 is formed on the top rim of the second lenses 2, which comprises a body in the shape of cornered pillar, and an opening 22 disposed below the body of the pivot rod.

Referring to FIG. 3, as the trough 31 of the eyeglasses frame 3 is in pivot connection with the pivot rod 21 of the second lenses 2, the entry 32 of the trough 31 has a width smaller than that of the cross-section of the pivot rod 21, and the entry 32 is provided with a guiding slope 33 leaned outward, which enables the pivot rod 21 to be pressed with force into the trough 31 through the guiding slope 33. The pressing will broaden the entry 32 to accommodate the pivot rod 21 completely in the trough 31, where the entry 32 will restore immediately (due to the plastic traits), to keep the pivot rod 21 in the trough 31 from coming off. At the moment, the bottom portion of the socket 30 will penetrate the opening 22 for a stay and without being hindered.

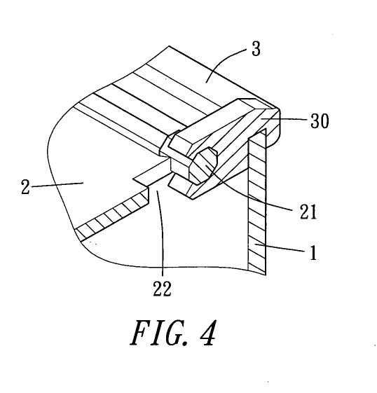

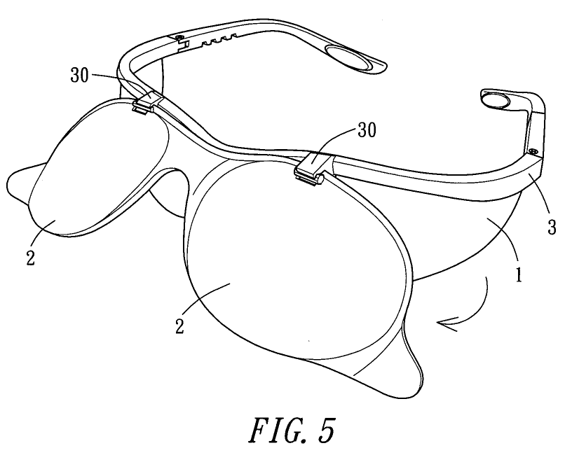

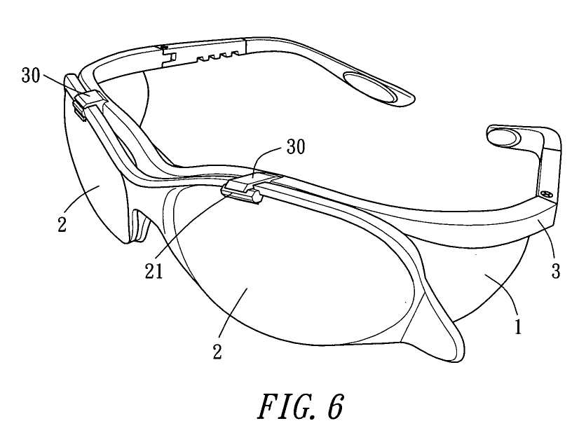

Referring to FIG. 4, the pivot rod 21 is in pivot connection with the trough 31 of the eyeglasses frame 3. Once the second lenses 2 are being lifted, the body of the pivot rod 21 will be forced to rotate in the trough 31, and will stop in a new position. The internal space of the trough 31 can be formed a bit smaller than (but almost same as) the cross-section of the pivot rod 21. When the user lifts the second lenses 2 (shown in FIG. 5) or lowers it to juxtapose with the first lenses 1 (shown in FIG. 6), the second lenses 2 will not come off from the trough 31. Any moment the hand quits pushing, the second lenses 2 stay right there, which precisely positions the lenses.

Once the second lenses 2 is required to tear down from the eyeglasses frame 3 (demount the second lens 2), the way is just to reverse the whole mounting procedure, which is to pull the pivot rod 21 ahead with force to jostle against the entry 32 to be broadened, and the pivot rod 21 is then ready to come off from the hold by the trough 31. The entry 32 is then immediately restored (due to the plastic traits), and is ready for the mounting of the second lenses 2 again.

Accordingly, as the second lenses 2 of this invention is being lifted (shown in FIG. 5) or lowered (shown in FIG. 6), the second lenses 2 and the eyeglasses frame 3 are in a firm positioning, which means to mount the cornered-pillar pivot rod 21 into the cornered-groove trough 30 is a perfect fit without any gaps in between, and it helps to position the clip-on lenses precisely.

In conclusion, the present invention indeed accomplishes the expected functions and objective, and the disclosure of this application is ample enough for those skilled in the art to realize it, where the aforesaid exemplified embodiments of the present invention is used only for the illustration; any equivalent embodiments or modifications without departing from the spirit and scope of the present invention are therefore intended to be embraced.

What is claimed is:

1. A structural combination of eyeglasses with attached second lenses, comprising an eyeglasses frame, a first lenses and a second lenses, where the eyeglasses frame is provided with protruded sockets on its top rim, and the socket having a trough in the shape of multiple corners at its internal, while the second lenses is provided with pivot rods in the shape of multiple corners, and the pivot rods being lodged in the troughs of the eyeglasses frame, once the pivot rods of the second lenses being in pivot connection with the troughs of the eyeglasses frame, the user being ready to lift or lower the second lenses, subject to the demand.

2. A structural combination of eyeglasses with attached second lenses as in claim 1 wherein the entry of the trough of the socket faces preferably the front of the eyeglass.

3. A structural combination of eyeglasses with attached second lenses as in claim 1 wherein the entry of the trough of the socket is provided with a guiding slope leaned outward.

4. A structural combination of eyeglasses with attached second lenses as in claim 1 wherein the second lenses are provided with an opening below the body of each pivot rod.
